(19) United States
(12) Patent Application Publication
(10) Pub. No.: US 2002/0138432 A1
(43) Pub. Date: Sep. 26, 2002

(54) System and method for reporting customer visits to a bank or the like

(75) Inventors: Katsuhiko Makino, Tokyo (JP); Akihiko Sugawara, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Asahi Bank, Ltd., Tokyo (JP)

(21) Appl. No.: 09/990,888

(22) Filed: Nov. 9, 2001

(30) Foreign Application Priority Data
Mar. 21, 2001 (JP) 2001-080857
Mar. 21, 2001 (JP) 2001-080885

(51) Int. Cl. G06F 17/60

(52) U.S. Cl. 705/43

(57) ABSTRACT

A bank network having automated teller machines (ATMs) located at a bank branch, wherein effective business promotion activity can be tailored for customers conducting transactions at the ATMs. An integrated center communication system collects customer attribute information and service offer (promotional display) information, and transfers that information to a business store communication system at the bank branch. The business store communication system downloads and stores the collected customer information transferred from the integrated center communication system. When a customer uses an ATM at the bank branch, the customer's attribute information is read and reported to bank employees, so that a bank employee is able to approach the customer, for example, to explain services offered by the bank. The reporting is accomplished through the use of wireless transmissions to personal digital assistants carried by the bank employees. Updated customer information, based on the customer's current transaction and reaction to promotion activity, can be stored and later transferred to the integrated center communication system.

### BACKGROUND OF THE INVENTION

The present invention relates generally to a method and system for reporting commercial activities and information. More particularly, the present invention relates to method and system for reporting information collected by a bank, such as bank account information, bank customer visits, bank transaction activities and the like.

In current banking systems, an ATM disposed at the head office or branch office of a bank performs transactions such as deposit or withdrawal of cash, transfer of funds between accounts and other similar transactions, according to the customer's operation of the ATM and the information displayed on the ATM screen. This screen displays various forms of guidance (instructions and information on use), in addition to information relating to the customer's account or the transaction being conducted. A bank having an ATM network typically has an accounting system (running on a host or central mainframe computer system) located at the bank headquarters or integrated system center, for controlling all financial transactions at the bank and its branches, and a central business system (also at the headquarters or integrated system center) for storing and processing customer attribute information (information about each customer, such as customer name, account numbers, and customer transactions). The customer attribute information is stored in an integrated customer database file system (called a Marketing Customer Information File or “MCIF”) within the central business system. A number of ATMs or self-service terminals are connected to the host computer through a closed or dedicated communication network. The ATMs may be disposed at bank branch offices, as well as at other locations accessible to the public, such as retail stores.

In addition to the central business system, each bank branch or store also has a business system with an MCIF system. The branch or store MCIF periodically receives customer attribute information from the central MCIF by way of the bank communications network, and as customer activity takes place at that branch, it updates that information. In addition, the branch MCIF system periodically transfers its updated customer information back to the central system so that it can be collected and stored, and subsequently downloaded and used by all the branches.

The branch business system also receives business campaign information (data pertaining to screens or guides displaying promotional campaigns or offers that may be presented to customers at the ATMs). Among other things, the promotional campaign might involve awards or offers of bank services to the customer when he/she comes to the branch or store. Such awards and services are part of the display on the screen of the ATM, achieved by the data transfer between the branch (business store) management MCIF system and the ATM.

In the above conventional example, although giving awards or points and offering services is performed when the customer comes to the store, an effective business promotion is not always achieved. This is because this service offer (for example, awards, points or premiums) is executed at a counter (e.g., by a teller or customer services representative) of the business store to which the customer needs to come. The customer does not always want to come to the counter to receive the service offer.

Moreover, in the past, a business promotion that matches the individuality of a customer has not been achieved. That is, past business activity has been carried out by collecting personal attribute information (anticipated customer preferences, customer name, customer address, etc.). Further, since the business promotion for the customer is uniformly executed by displaying awards/points and service offers (and issuing a game card at the ATM), and does not use a personal interview with the customer, the degree of customer interest in the campaign or service offer is not made clear.

In other words, since the status of bank utilization is not obtained more accurately, “one-to-one” marketing (permission marketing), and other marketing activity, which matches the individual attribute or condition of each customer, is not available for a more effective business promotion.

The present invention is used to solve the problems in such prior art. One embodiment of the present invention provides a communicative reporting method of the customer's visit to the bank branch or store. Another embodiment provides a bank communication system which collects and updates data on the customer's use of services, such updating occurring at both the main branch and the plurality of branch offices. The system reports customer visits to the bank or store to various bank offices together with the status of bank utilization (use of bank services) information, along with the current campaign and service offer information, thereby enabling an effective business promotion activity that is matched to each customer.

### BRIEF SUMMARY OF THE INVENTION

There is provided in accordance with one embodiment of the present invention a method and system for reporting on a customer that visits a commercial establishment, such as a bank. The bank has a central system at a bank main office and a branch system, including ATMs, at a branch office. Customer attribute information (personal information associated with the customer) and customer service information (information associated with services offered by the bank) are stored at the central system and periodically transferred to the branch system. When a customer conducts a transaction at an ATM, customer specific information identifying the customer is generated. The branch system transmits a report in response to the customer-specific information, such report identifying the customer and the customer service information, so that a bank representative may approach the customer.

The bank representative may explain the customer service information or otherwise offer assistance to the customer. After the report is transmitted and the customer approached, the customer attribute information is updated at the branch system (reflecting the customer's current transaction or the reaction of the customer to the customer service information), and such updated information is later transferred to the central system.

In other embodiments, terminals are used by bank representatives for receiving the report transmitted by the branch system. The terminals may be either stationary or portable. In the case of a portable terminal (personal digital assistant), the report may be transmitted by wireless transmission from the branch system.

In further embodiments, a communicative report method of a customer's visit to the store and customer information for a business activity of the present invention allows an apparatus on the side of a business store to download the customer information at least including status of bank utilization and the name of the customer in an automated teller machine from equipment on the side of collection and distribution, and communicatively reports the customer's visit to the store and the customer information to a device on the side of a person in charge of business, comprising the steps of:

collecting information contents in a plurality of items including the status of bank utilization and the name of the customer in which the customer information is subdivided;

allowing the side of the collection and distribution to transfer this gathered customer information to the side of the business store;

allowing the side of the business shop to download the gathered customer information transferred from the side of this collection and distribution;

reading the downloaded and stored customer information when the apparatus on the side of the business store subsequently recognizes the customer's visit to the store including the use start of the automated teller machine by the customer;

communicatively reporting the customer's visit to the store and the customer information to the unit on the side of the person in charge of business;

allowing the side of the business shop to transfer new customer information for each customer obtained after this communicative reporting to the side of the collection and distribution; and

allowing the side of the collection and distribution to rewrite the currently stored customer information to transferred new customer information.

The method of the present invention, in the step where the side of the collection and distribution transfers the customer information to the side of the business store, is characterized in that the customer information is automatically transferred at the preset time.

The method of the present invention, in the step where the side of the collection and distribution transfers the customer information to the side of the business store, is characterized in that the customer information is transferred in accordance with a request from, the side of the business store.

The method of the present invention is characterized in that the customer information transferred in accordance with the request from the side of the business store is the customer's personal information that the side of the business store designates.

The method of the present invention is characterized in that the customer information that the side of the collection and distribution transfers to the side of the business store is the information contents in the preset item or the information contents in all stored items.

The method of the present invention is characterized in that the step of displaying the screen indicating that the person in charge of business pays a visit to the customer on the display screen of the automatic teller machine is further included after the step of communicatively reporting the customer's visit to the store and the customer information to the apparatus on the side of the person in charge of business.

The method of the present invention is characterized in that the new customer information for each customer obtained after the communicative reporting is the information for each customer concerning the status of use of the automated teller machine or the information in which the information obtained when the person in charge of business makes contact with the customer is input to the unit on the side of the person in charge of business.

The method of the present invention is characterized in that the customer who performs the communicative reporting is a customer in the preset special bank account state.

The method of the present invention is characterized in that the side of the person in charge of business receives communicative reporting of the customer's visit to the store and the customer information in a movable state or receives it in a fixed state including the state where he or she sits on a chair.

The method of the present invention is characterized in that the step of deleting the downloaded and stored customer information and the new customer information is further included after the side of the business store transfers the new customer information for each customer obtained after the communicative reporting is transferred to the side of the collection and distribution.

Moreover, collection, distribution, receiving, and display methods of status of bank utilization information of a customer in the present invention are constructed so that the equipment at the side where the customer information is collectively collected and distributed collects individual customer transaction information from the apparatus on the side of the business store via two-way communication means and sends the updated customer information to the side of the business store, and then the side of the business store receives and displays the customer information, comprising each step of:

allowing the side of the collection and distribution to collect the information contents in the plurality of items including the status of bank utilization and the name of the customer in the customer information is subdivided;

allowing the side of the collection and distribution to transfer the collected customer information to the side of the business store;

allowing the side of the business store to download the collected customer information transferred from the side of the collection and distribution;

reading and displaying the stored customer information of the customer when the apparatus on the side of the business store recognizes the customer's visit to the store including the use start of the automated teller machine;

allowing the side of the business store to transfer the new customer information concerning the customer to the side of collection and distribution; and

allowing the side of the collection and distribution to additionally write or rewrite the currently stored customer information to the transferred new customer information.

A bank communication system of the present invention communicatively reports customer information at least including status of bank utilization and a name of a customer in an automated teller machine when the customer comes to the store, comprising:

an integrated center communication system that collects and transfers the information contents in a plurality of items including the status of bank utilization and the name of the customer in which the customer information is subdivided and rewrites the currently stored customer information to the transferred new customer information;

a business store communication system that reads the stored customer information to perform communicative reporting when the gathered customer information transferred from the integrated center communication system is downloaded and stored and the customer's visit to the store including the use start of the automated teller machine is recognized by the customer, and transfers the new customer information for each customer downloaded after this communicative reporting and deletes the stored customer information and the new customer information; and

a business store communicative reporting system that receives and displays the communicative reporting from the business store communication system.

In the business store communication system, the new customer information for each customer downloaded after it is displayed is the information based on the use of the automated teller machine or the information input in the business store communication system.

The system of the present invention is characterized in that the integrated center communication system and the business store communication system are housed in a TCP/IP network that executes two-way communication.

The system of the present invention is characterized in that the business store communicative reporting system comprises a transmitter that performs the communicative reporting by means of a radio wave.

The system of the present invention is characterized in that the business store communicative reporting system comprises a receiver that receives and displays the communicative reporting via a weak radio wave from the business store communication system.

The system of the present invention is characterized in that the business store communication system comprises communication equipment that performs two-way communication via a weak radio wave for the communicative reporting.

The system of the present invention is characterized in that the business store communicative reporting system comprises communication equipment that performs the two-way communication via a weak radio wave from the business store communication system.

The system of the present invention is characterized in that the two-way communication equipment is a cellular phone and a mobile computer that substantially operates as a computer which is wire-connected to this cellular phone or a fixed information processor or a fixed information processor that substantially disables portability.

The system of the present invention is characterized in that the two-way communication equipment is a mobile computer that substantially operates as a computer having a cellular phone and wireless line connection equipment which is wirelessly connected to this cellular phone.

The system of the present invention is characterized in that the business store communication system comprises a transmitter for performing communicative reporting through a wire and the business store communicative reporting system comprises an information processor that receives and displays the communicative reporting from the transmitter.

The system of the present invention is characterized in that the business store communication system comprises screen display means that displays customer information and at least one of sound output means, vibration display means, and screen change processing means.

The system of the present invention is characterized in that the two-way communication via a weak radio wave for the communicative reporting is executed through an in-house radio communication network or a public mobile communication network.

The system of the present invention is characterized in that the main store communication for executing processing including the registration of the customer information and processing version upgrade setting in the integrated center communication system and/or the business store communication system.

In such present invention, the status of bank utilization of the customer extending over the main store and a plurality of business stores is collected and updated on the side of the collection and distribution (integrated center communication system) via the communication line network. This collected information is downloaded and stored by the side of the business store (business store communication system), and, based on this status of bank utilization, the customer's visit to the store is reported to the side of the person in charge of business via the business store communicative reporting system together with the information about the status of bank utilization of the customer.

Accordingly, a person in charge of business and an administrator who have received the communicative reporting can immediately perform the effective business promotion activity in which they interview with the customer. In other words, the detailed “one-to-one” marketing/permission marketing for each customer is enabled.

Further, in the present invention, the person in charge of business and the administrator can immediately recollect more accurate information of the status of bank utilization via the business promotion activity to the customer. Accordingly, based on the information about this new status of bank utilization of the customer, the more effective business promotion activity is enabled for each customer who will come to the store in the next time.

### BRIEF DESCRIPTION OF THE DRAWINGS

FIG. 1 is a schematic block diagram of a banking network according to one embodiment of the present invention;

FIG. 2 is a block diagram of the ATM in the network of FIG. 1;

FIG. 3 illustrates one embodiment of the branch office system and various configurations of personal digital assistants for use therewith;

FIG. 4 illustrates a different embodiment of the branch office system and various configurations of personal digital assistants for use therewith;

FIG. 5 is a block diagram of the banking network, illustrating the program protocol stacks in the ATM, in the branch office communication system, and in the integrated center communication system (ICC system) of such network;

FIG. 6 is a diagram illustrating the flow of data between the ICC system and two branch office systems, according to an embodiment of the present invention;

FIG. 7 is a flowchart illustrating the download and upload procedures for tile transfer of customer information between the ICC system and a branch office communication system according to an embodiment of the present invention;

FIG. 8 is a flowchart of a detailed upload procedure for the transfer of customer information from the ICC system to a branch office communication system according to an embodiment of the present invention;

FIG. 9 is a drawing illustrating the storage of customer information in a database in the branch office communication system seen in FIG. 1;

FIG. 10 illustrates in greater detail the storage of customer information in the database;

FIG. 11 is a flowchart illustrating processing procedures between the ATM and a branch office management MCIF system according to an embodiment of the present invention;

FIG. 12 is a block diagram illustrating (in a different form) the same processing procedures between the ATM and the branch office management MCIF system;

FIG. 13 is a drawing showing a scratch card issued to a customer at an ATM;

FIG. 14 is a drawing illustrating the operation of the branch office communication system and a PDA for purposes of facilitating contact between a customer and a customer service representative;

FIG. 15 is a flowchart illustrating the process for reporting customer information at a PDA;

FIG. 16 (consisting of FIGS. 16(a) and 16(b)) illustrates two sequential screens on a PDA for displaying information on customers visiting a bank branch office; and

FIG. 17 (consisting of FIGS. 17(a) and 17(b)) illustrates two additional sequential screens on a PDA for displaying information on customers visiting a bank branch office.

### DESCRIPTION OF PREFERRED EMBODIMENT

A reporting system and method in accordance with the present invention will now be described with reference to the drawings. In connection with this description, it should appreciated that although embodiments of a reporting system and method are described as used in a banking network wherein customers conduct transactions at automated teller machines (ATMs), the present invention is not so limited. For example, the invention will have application to retail stores where customers may conduct retail transactions electronically at self-service terminals. In general the present invention would be useful at any retail, financial or other commercial establishment where special offers or promotions may be made to a customer using a self-service terminal, and where the reporting of the presence of the customer at the terminal will aid the establishment in its relationship with the customer, will assist the establishment in making offers or promotions or conducting other business activity with the customer, or will enable the collection of updated information about the customer, including the reaction of the customer to such business activity.

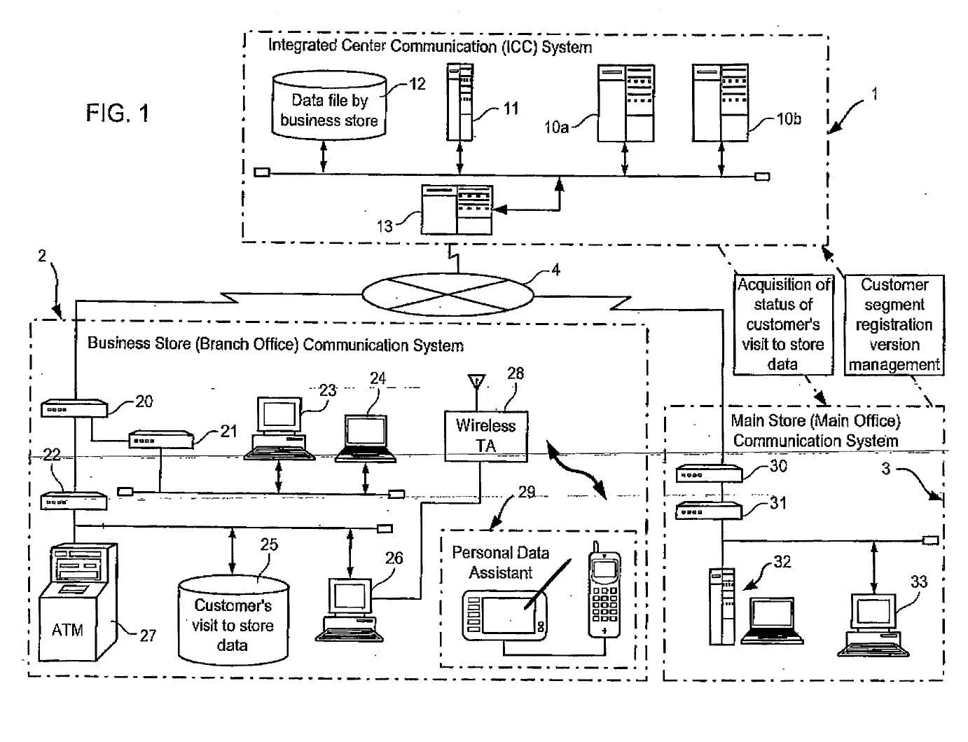

In FIG. 1, a bank network in accordance with the present invention has an integrated center communication (ICC) system 1 installed at the main store (main office) or other management center of a bank, a business store (branch office) communication system 2 installed at a branch office or ATM installation site of a bank, a main store (main office) communication system 3 that integrates and processes customer information (for example, customer information registration or version upgrade management), and a frame relay network 4 (operating as a TCP/IP network) to which the communication systems 1 through 3 are connected.

The integrated center communication (ICC) system 1 shown in FIG. 1 comprises MCIF server units 10 (10a, 10b) as MCIF systems, a management server 11 that executes backbone computer processing, and a database device 12 that updates, collects, and transfers collected information (in this embodiment, customer information—information on the use of bank or ATM services by each customer). Further, the ICC system 1 has a communication controller BCN 13 for executing communication control with the frame relay network 4.

The business store communication system 2 shown in FIG. 1 comprises, for example, a router 20 running a firewall application (for preventing intrusion), a concentrator (hub) 21, a switch 22, and various small general purpose computers 23 and 24 for business information processing and reporting. The hub 21 interconnects the computer 23, the computer 24 and other equipment in a local area network (LAN) configured according to a 10BASE-T specification.

The business store communication system 2 further comprises a database device 25 and a business store MCIF server 26 (collectively functioning as a business store management MCIF system) and a plurality of automated teller machines (ATMs) 27, only one of which is seen in FIG. 1.

The database device 25 stores (and updates) information about the utilization (customer use) of that branch by customers and transfers the updated customer information to the integrated center communication system 1. Further, the database device 25 receives and stores information on bank utilization (customer use across the entire network at all branches) from the integrated center communication system 1.

Moreover, the business store communication system 2 also has a wireless terminal adapter (wireless TA) 28 that receives customer information pertaining to a specific customer from the server 26 when that customer comes to the branch. The wireless TA 28 transmits that customer information to a personal digital assistant 29, which displays it on a screen. For purposes of such wireless transmission, the business store communication system 2 may use a conventional wireless telecommunications system. The details of such a telecommunications system are beyond the scope of the present invention, although those skilled in the art will appreciate that any TDMA or CDMA system currently in use in the U.S., Japan or Europe could be used. Alternatively, a conventional low power, in-house wireless system could also be used.

The combination of the server 26, wireless TA 28, and personal digital assistant 29 serve as a business store communication and reporting system, permitting customer information to be displayed to bank branch employees for purposes to be described in detail later.

The business store communication system 2 may also have an Uninterruptible Power Supply (UPS) that performs battery backup and a page printer that performs various print outputs, neither of which is shown in the drawings.

Depending on the type of wireless system used, the wireless TA 28 in the business store communication system 2 includes conventional components such as a frequency switching synthesizer (for permitting communication with the personal digital assistant 29) and a wireless handset unit having a receiving field intensity (RSSI) sensing unit, a modulator or demodulator unit, a time division multiplexing unit, a codec (coding or decoding) unit, a microprocessor (MPU), an internal interface (I/F for connecting the server 26), and a memory.

The personal digital assistant 29 also includes conventional components such as a frequency switching synthesizer and a wireless handset unit having a receiving field strength (RSSI) sensing unit, a modulator or demodulator unit, a time division multiplexing unit, a codec (coding or decoding) unit, a microprocessor (MPU), an external interface (I/F) unit, a memory, a display unit such as a keypad and an incoming display light emitting diode or a liquid crystal display, a transmitting microphone, and a speaker.

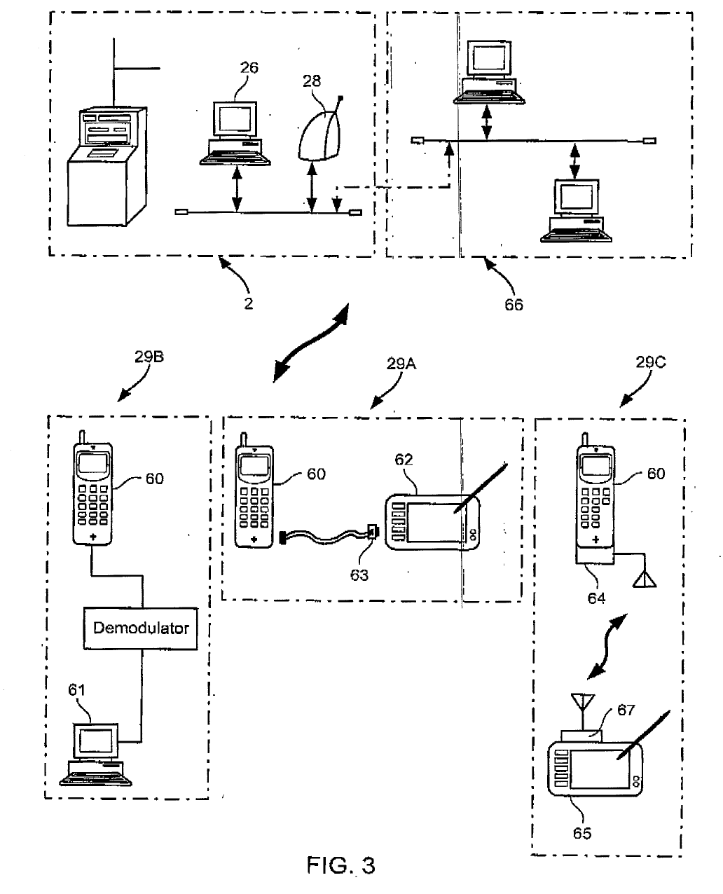

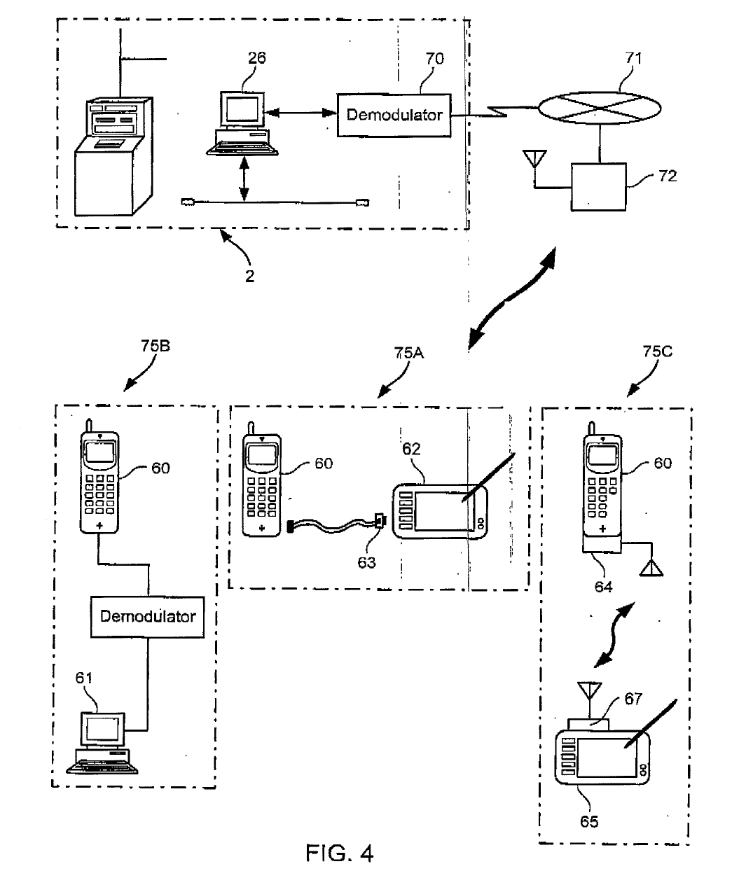

The personal digital assistant 29 may have several different embodiments, where either a fixed display or terminal or, alternatively, a portable display or terminal may be used by bank employees to receive reports of customer information. These alternative embodiments will be described in detail later in conjunction with FIG. 3 and FIG. 4.

The main store (main office) communication system 3 shown in FIG. 1 comprises a router 30, a switch 31 and a MCIF system implemented by a server 32 and a computer (main store MCIF client) 33.

The frame relay network 4 shown in FIG. 1 is conventional, such as an ISDN network in which a Private Branch Exchange (PBX) is installed in the line network.

Alternatively, the frame relay network 4 may be implemented with other high-speed transmission systems (for example, an asymmetrical digital transmission system or gigabit high-speed data communication system). Further, the frame relay network 4 may be implemented in a Public Switched Telephone Network (PSTN) if the amount of data traffic (from the transfer of business information between branches and the main office) in the bank network is small.

The MCIF server 10 (10a, 10b) shown in FIG. 1 has a communication protocol function and a database tracking processing function, and the operation is basically the same operation as a general purpose computer.

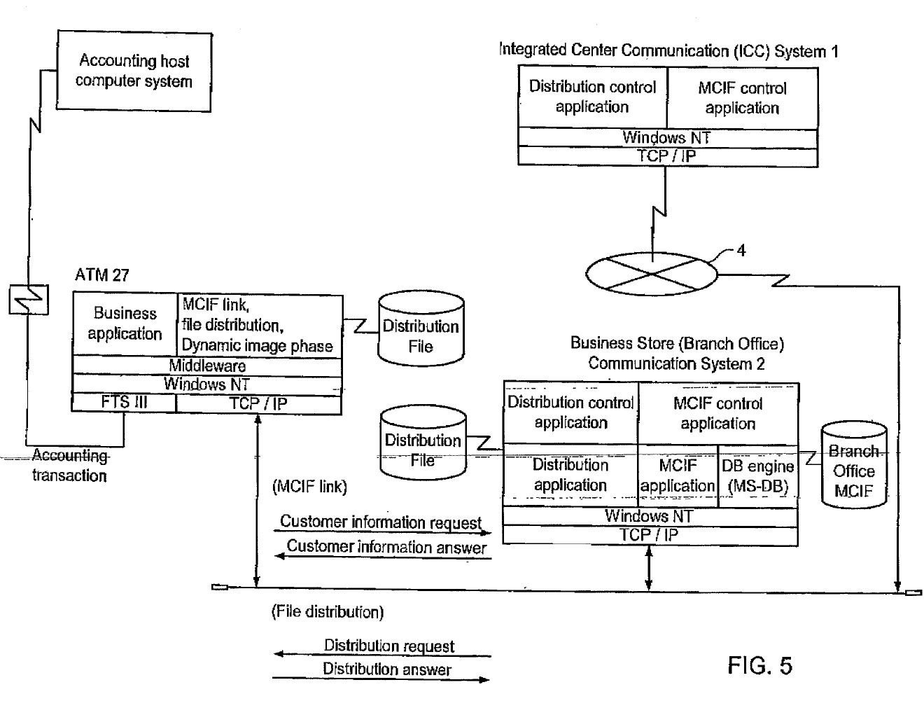

The configuration shown in FIG. 1 corresponds to a business system that collects, processes, stores and uses customer business information (e.g., status of bank utilization information) for each customer. Further, an accounting system (shown only in FIG. 5) is located in a main office or central location and manages customer financial or account information in order to deal with cash depositing and withdrawing and money transfer to and remittance from a bank. These business systems and accounting systems may be independent in the communication network configuration, with the accounting system connected to branch offices by a private dedicated communications line and the business systems interconnected (as described earlier) over a PSTN (public switched telephone network) or other public network. The accounting system is a backbone system of the bank, and requires large amounts of time and costs even for a slight system modifications. Accordingly, since the accounting system cannot easily be modified, the present invention and various modifications and programming that will implement embodiments of the present invention can be done on the business system. Since the accounting system is not directly related to the present invention, further illustration and description thereof are omitted.

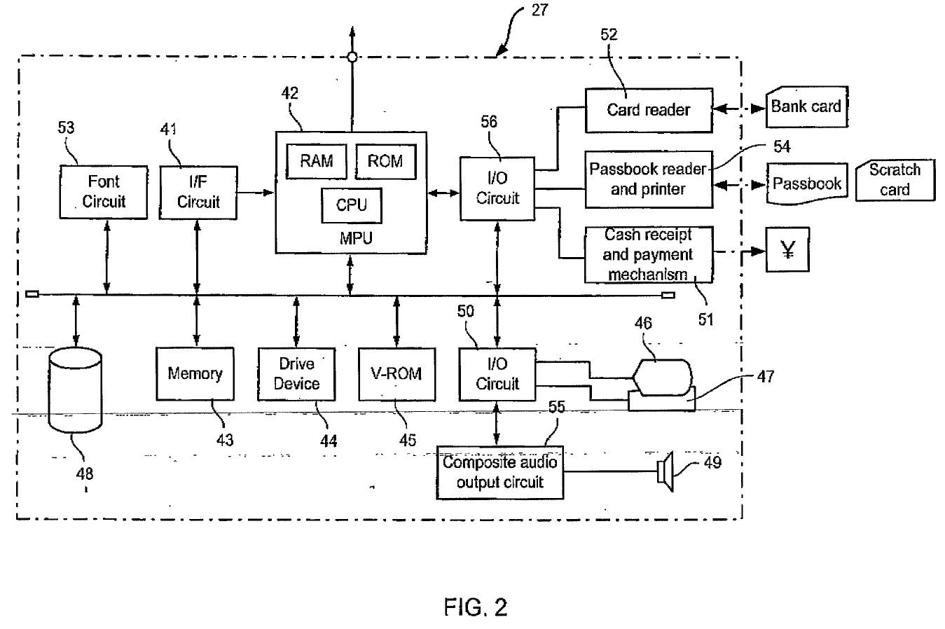

FIG. 2 is a block diagram showing the principal components of the ATM 27.

In FIG. 2, the ATM 27 is conventional and comprises an interface (I/F) circuit 41, a microcomputer 42, a memory 43, a drive 44 for an information recording medium, and a video (V)-ROM 45. Further, the ATM 27 comprises a color display device (CRT or LCD) 46, an input console 47 (e.g., a touch panel), a hard disc unit 48 as a database in which the customer information is stored, an audio output speaker 49, and an I/O circuit 50 as an interface to the display device 46, the input console 47 and a composite audio output circuit 55 going to the speaker 49.

The ATM 27 further comprises a cash receipt and payment mechanism 51, a card reader 52 for receiving and reading a customer card, a font circuit 53 for screen display (for example, in which dot fonts are stored in order to create characters on the screen), and a passbook reader and printer 54. An I/O circuit 56 serves as an interface to the cash mechanism 51, card reader 52, and passbook reader and printer 54.

The integrated center communication (ICC) system 1, the business store (branch office) communication system 2, and the main store (main office) communication system 3 execute the present invention according to a communication protocol or program that an MPU in each executes. This communication protocol or program is installed by combining a dedicated communication protocol or program for executing the present invention together with a general purpose TCP/IP communication protocol or program. The communication protocol or program may be distributed as a general purpose software package (information recording medium, such as a CD-ROM or MO), a semiconductor solid-state device, or a digital signal processor (DSP). The programs and protocol could also be delivered to the various systems by being transmitted over a communication network.

Before describing the further details of the bank network, the overall operation and use of the bank network (FIG. 1) and the ATM 27 (FIG. 2) within that network will now be described.

As briefly mentioned earlier, embodiments of the present invention enable a bank to obtain and store updated information on customers and their status, and to take advantage of that information (by offering services/promotions) when a customer visits a bank to conduct a transaction. The nature of the information collected for customers will depend on the services that the bank might want to promote or offer. Examples of information include customer name, account number(s), frequency/number of ATM transactions, past non-ATM banking services provided to the customer, previous promotional campaigns used/accepted by the customer, customer attribute information (e.g., homeowner/renter, age, balance in accounts, etc. ) and any other information that would be useful in determining whether a customer is a candidate for specific services offered by the bank. Customer information is collected at the ICC system 1 and stored in the database 12. Under the control of the main store system 3, the ICC system 1 periodically polls bank branches and collects data to update the stored information (e.g., information on recent visits or ATM transactions at that branch, etc.). In addition, the main store system 3 periodically controls the operation of the ICC system 1 and each business system 2 in order to synchronize and register the customer information and data (i.e., make sure that every branch office and the ICC system 1 have the same, updated information).

The ICC system 1 is programmed to offer specific services and promotions to customers based on the customer information stored. If certain categories of customers would have interest in specific services, the ICC system 1 can be programmed to provide appropriate screen displays to the business system 2 for those customers. As one example, customers having large account balances might benefit from investment services, and those customers would have displayed at the ATM 27 an offer to provide investment services. As another example, a customer who seldom visits an ATM might see a screen offering a “scratch” or game card, with information provided on the screen as to how to redeem the card after it is dispensed by the ATM, thereby encouraging the customer to more frequently use the ATM. In still a further example, a customer who is “preferred” (e.g., a customer having large account balances) might see a screen informing them that a customer service representative is available to help them if they have questions or need help with transactions being conducted at the ATM (as will be described later, in one embodiment the customer service representative is simultaneously alerted that the customer is at an ATM on the bank premises). These are, of course, only a few of many possible circumstances where the bank might offer specific promotional services and provide the corresponding screens to be displayed at the ATMs 27.

The ICC system 1 is also programmed to periodically download customer information and associated screen display data to the business system 2 at each bark branch. Thus, for example, every customer that is a candidate for investment services, is identified (for example by customer name or ID) by the ICC system 1, and the ICC system downloads to the business system 2 programming to display such a screen when that customer initiates a transaction at an ATM at that bank branch.

When a customer visits a bank and inserts his/her card into the card reader 52 of the ATM, the server 26 causes the screen display to be downloaded from the database 25 to the ATM. As will be described later, at the same time as a promotional screen is displayed, the server 26 sends data to the wireless TA 28 identifying the customer (as well as any information about the customer that might be useful to bank employees). Such data is transmitted to one or more of the PDAs 29. Thus employees of the bank can be alerted that the customer is visiting the bank and conducting a transaction at the ATM. This arrangement is particularly useful where a promotional offer is being made to a customer at the ATM, and the bank would like to have a customer service representative explain the service in addition to having information on the service displayed at the ATM screen. As will also be described later, this arrangement also permits the bank to get updated information on the customer and his reaction to (accepting/declining) the promotional offer. The bank employee can enter that information into the business system 2 (e.g., at the computer 23 or 24) in order to update that customer's records, reflecting that the customer has been offered and has accepted/declined the promotional offer. Such information is periodically uploaded (along with other customer information collected at the bank branch) to the ICC system 1.

FIGS. 3 and 4 illustrate a detailed configuration of the personal digital assistant 29 of FIG. 1, as well as various alternative embodiments of the personal digital assistant 29.

Referring to FIG. 3, the business store communication system 2 (with some portions omitted for ease of illustration) uses the wireless TA 28 for transmitting customer information from the server 26 for display on the personal digital assistant 29 (29A, 29B,29C).

The personal digital assistant 29A may be used by a bank employee (Floor Staff or customer service representative), and includes a cellular wireless phone 60 and a palmtop, mobile computer 62. This cellular phone 60 and the palmtop computer 62 are connected (wired connection) by a demodulator 63 and a cable.

Further, the personal digital terminal 29B may include a wireless phone 60 and a small general purpose computer 61 as a fixed information processor. The cellular phone 60 and the small general purpose computer 61 are wired together through a demodulator (transmitter).

The personal digital assistant 29C may include a wireless phone 60 having a handset interface 64 using a bluetooth system as a low powered radio or wireless connection device for communicating with a palmtop computer 65. The palmtop computer 65 likewise has a handset interface 67 using a bluetooth system.

A management device 66 that performs the same operation as the personal digital assistant 29 may also be provided. This management device 66 is a small general purpose computer installed, for example, on a desk or at a teller counter at the bank branch. This management device 66 may be used to give advice to bank employees having personal contact with the customer. Additionally, the deposit manager, the finance manager, and the branch manager may use the management device 66 to perform an effective business promotion activity for each customer.

The various computers within the management device 66 may be part of a LAN (LAN server is omitted), and connected by a wired or other interface (for example, connected by a USB/SISC interface).

Referring to FIG. 4, in this example, a PHS public mobile communication network (i.e., Personal Handyphone System, a TDMA system in common use, for example, in Japan and other countries outside the U.S.) may be used instead of the wireless TA 28. In this example, a demodulator 70 is connected to the server 26 of the business store communication system 2 and a digital mobile telephone line network 71 is connected to this demodulator 70. This example includes personal digital assistants 75A, 75B, 75C that basically have the same configurations and perform the same operations as the personal digital assistants 29A to 29C in FIG. 3. The wireless phones 60 in the personal digital assistants receive wireless communication via an external wireless transmission/receiving device (cell base station) 72 connected to the digital mobile telephone line network 71.

The integrated center communication system 1, the business store communication system 2, and the main store communication system 3 execute the program protocol stack shown in FIG. 5.

FIG. 5 is a drawing for illustrating the principal functional components of the program protocol stack for the bank network shown in FIG. 1.

However, before describing such program and protocol stacks, it is useful to again refer to the overall operation of the network seen in FIG. 5.

After updated customer information has been downloaded from the ICC system 1 to the business system 2, the actual display and presentation of offer information ( e.g., screen displays) is accomplished by two different data flows or processes.

First, business system 2 transfers all selected distribution files to each of the ATMs 27 in advance. As an example, the branch office may want to make twenty different promotional displays available to customers using ATMs at that branch. The promotional or offer information (in the form of distribution files) is transferred and stored in those ATMs. This transfer of distribution files is illustrated at the bottom of FIG. 5 as the “Distribution request” (sending the distribution files) and the “Distribution answer” (acknowledging receipt of the distribution files).

Secondly, when a customer uses an ATM (and inserts his/her bankcard into the card reader), the ATM reads customer identifying data (transaction-specific customer information) from the card and sends that information (in the form a “Customer information request”) to the business system 2 (as well as to the central accounting system at a host computer in the main office, which handles the financial transaction of the customer, for example, after the customer sees the promotional screen and accepts or declines the promotional offer). In response to receiving the “Customer information request”, the business system 2 determines from stored customer attribute information which, if any, promotional displays will be presented to the customer. The business system 2 returns a “Customer information answer” to the ATM, instructing the ATM as to which promotional screen is to be displayed to the customer (among the twenty stored in the ATM).

Referring still to FIG. 5, the ICC system 1, the business system 2, and an ATM 27 in a branch office, execute the following communications protocol and programs (1), (2), and (3).

(1) In the ICC system 1:

a distribution control application (see description of distribution control application for business system 2),

an MCIF control application (see description of MCIF control application for business system 2),

an OS (WindowsNT), and

the TCP/IP (communications protocol).

(2) In the business system 2:

the TCP/IP (communications protocol),

an OS (WindowsNT), and

Distribution Application

This application manages the transfer (distribution) of files (distribution request) from the business system 2 to the ATMs 27. These files are transferred as “distribution files”. The files to be transferred include a dynamic image file (initial screen), a first static image file (screen during transmission), a second static image file (screen specific to each customer), a telop file (initial screen), and a complete or whole bank information file. During execution of the Distribution Application, the application manages both the files to be transferred as well as the file currently in use at the ATM.

Distribution Control Application

This is a function enabling an administrator of the branch office to manage the setting, registration, change, and the like of a distribution file. It is also possible to activate a distribution control application and access a distribution file by remote control from a remote place by installing this distribution control application into another terminal.

Distribution File

This distribution file storage has the file to be distributed and a file registered one generation before. That is, this file temporarily stores data (offer information and customer attribute information) to be transmitted to the ATMs. It holds both the current data being sent to the ATM (screen displays, etc.) and the data (screen displays) immediately preceding the current data.

MCIF Application

This is a function which receives transaction-specific customer information (part of the “customer information request”) from an ATM 27 and retrieves customer attribute information stored in the Branch Office MCIF (database 25 and server 26) of business system 2 (to determine if customer offer information is to be displayed at the ATM), and answers the ATM with this retrieval result (“Customer Information Answer”).

MCIF Control Application

This is a maintenance function used when an administrator at the branch office performs maintenance (deletion, addition, and update) of a customer DB or file. This MCIF control application makes it possible to activate an MCIF application and access a branch office MCIF file through remote control from a remote place by being installed into another terminal.

Branch Office MCIF

This is a function for retrieving a branch office MCIF in a customer DB by means of a database engine (e.g., Microsoft DB).

(3) In each ATM 27:

the TCP/IP (communication protocol),

a communication application (e.g., FIS III) for transmitting data between the ATM and the accounting system,

an OS (WindowsNT)

Middleware for assimilating (and accommodating) differences in OS among the different ATMs when running applications,

Business application (for execution of transactions with the accounting system),

Distribution file as described before, and

MCIF link (provides the feature of sending and receiving “Customer Information request”/“Customer information answer”), File Distribution (provides the feature of receiving distribution files and acknowledging the receipt of distribution files (“Distribution request”/“Distribution answer”), and Dynamic image phase (controlling the display and sequencing of images, e.g., in the distribution file).

Such programs and protocol stacks in (1) to (3) listed above perform a sequence procedure for a customer information request or customer information response in an MCIF link, and perform a procedure of a distribution request or distribution response in a File distribution, as described earlier.

The importing of service performance information (i.e., customer attribute information and customer offer information) adapted to a specific customer, from the ICC system 1 to the business system 2 will now be described.

The ICC system 1 at the head office of a bank extracts from its database a relevant customer list of each branch office. It extracts the customer's bank number, branch office number, and account number as a customer database for each of the extracted segments (conditions), sets an ATM screen number (customer offer information), and imports this customer service performance information by transferring it through the network 4 to the business system 2 where it is downloaded and stored.

The main store communication system 3 executes the registration and version management of customer segment information (e.g., individual information in which the collected customer information on the status of bank utilization is subdivided) to the integrated center communication system 1 and the processing that transfers the collected customer information from the integrated center communication system 1 to the business store communication System 2.

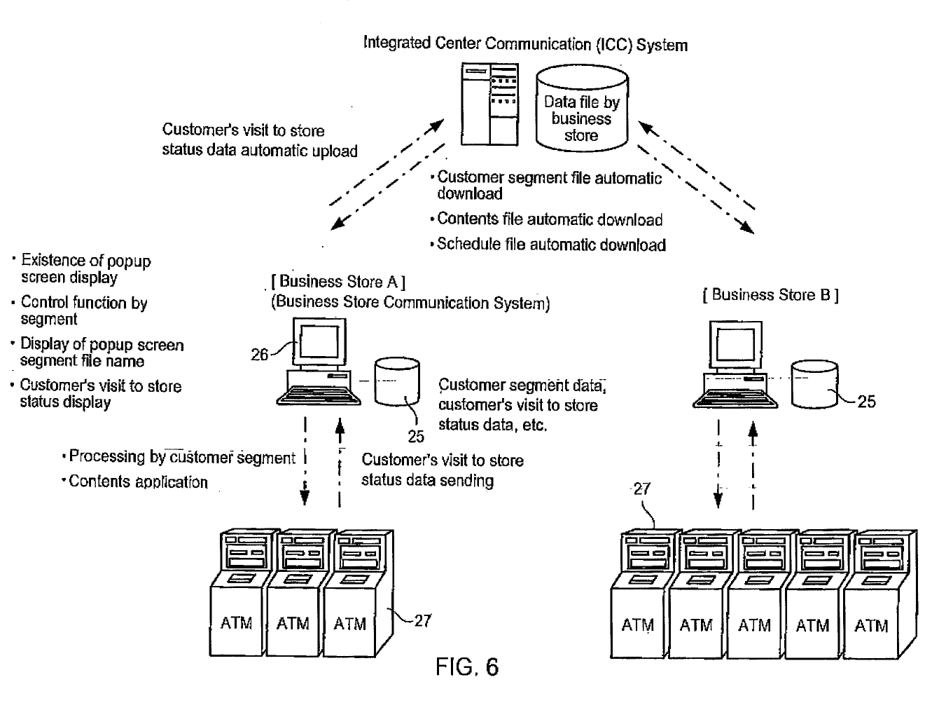

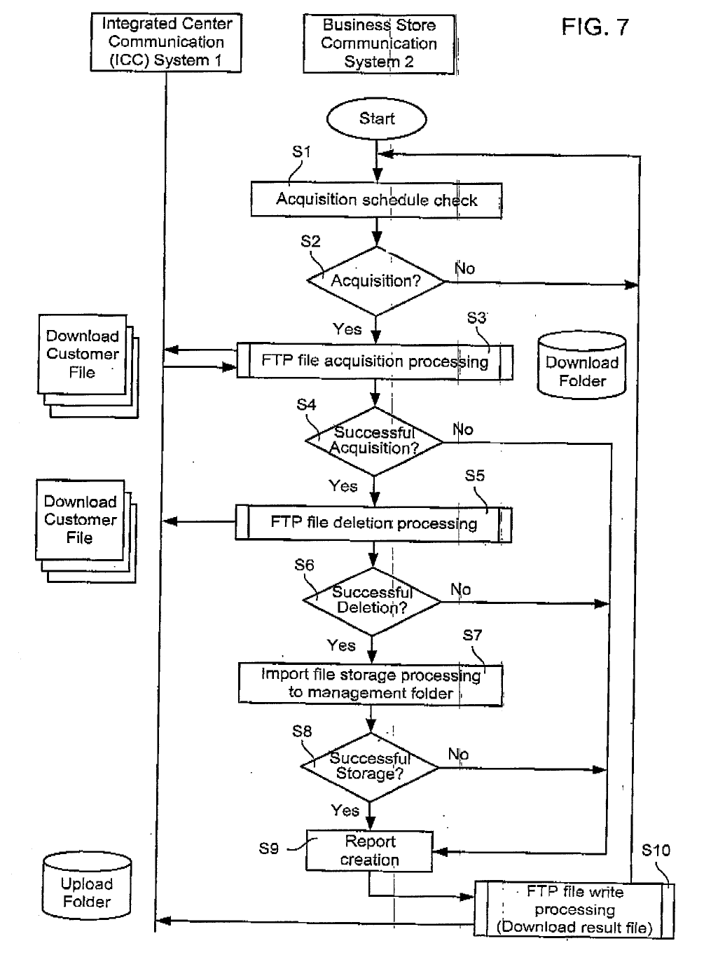

FIG. 6 is a drawing illustrating the flow of data between the integrated center communication system 1 and the business store communication system 2. FIG. 7 is a flowchart of the download and upload procedures for the transfer of customer information between the integrated center communication system 1 and the business store communication system 2.

In FIG. 6, the ATM 27 (in response to a customer initiating use of the ATM) sends data to the database device 25 and the business store MCIF server 26 notifying them of such use of the ATM and identifying the customer. In response to such data, the business store system sends appropriate screen display data to the ATM. Such screen displays may promote special bank services or cause the ATM to issue promotional scratch or game cards, depending on the attributes of such customer (the business store system will provide different screens based on different attributes of customers at the ATM). The ATM will also display conventional screens in order for the customer to conduct normal transactions at the ATM. Data generated from the customer's use of the ATM (e.g., number/type of transactions) is also transferred and stored in database 25.

Next, in FIG. 6 and FIG. 7, the business store communication system 2 judges an acquisition schedule for the transfer of the customer information (e.g., predetermined periodic transfers), which has been previously stored in the integrated center communication system 1 (steps S1, S2 of FIG. 7). This is all the information about the customer who is using this business store (branch office), updated to reflect recent use of ATMs 27 by that customer.

After the judgment of this step S2, the business store communication system 2 downloads the customer information from the integrated center communication system 1. This download includes, as shown in FIG. 6, the automatic download of the customer segment information (individual pieces of different information included in the stored customer information). These downloads are executed using an FTP (File Transfer Protocol), as shown in step S3 of FIG. 7.

The downloaded customer information is then stored in the database device 25 as a download folder (refer to FIG. 1). In the business store communication system 2, when acquisition of the FTP file is unsuccessful (step S4: No), processing moves to step S9 and an unsuccessful acquisition report FTP file is created. Subsequently, the FTP file is written and a download result file is reported to the integrated center communication system 1 with an upload folder (step S10).

In the business store communication system 2, when the acquisition of the ITP file is successful (step S4: Yes), the deletion of the FTP file (that corresponds to the customer information that is currently stored) is executed and the result is reported to the integrated center communication system 1 with a download customer file (step S5). The integrated center communication system 1 sets the customer information that is currently stored in the rewritten state.

Next, in the business store communication system 2, when the FTP file deletion is successful (step S6: Yes), the import file storage processing to a management folder (the database device 25 and the business store MCIF server 26 that are the business store management MCIF system) is performed (step S7). When this storage is successful (step S8: Yes), processing moves to step S9 and the success report of the FTP file acquisition is created. Subsequently, the FTP file is written and the download result file is reported to the integrated center communication system 1 with the upload folder (step S10).

Additionally, when the following are unsuccessful: acquisition (No) in step S4, deletion (No) in step S6, and storage (No) in step S8, then processing moves to step S9 respectively, and a failure report is created. Subsequently, the FTP file is written and the download result file is reported to the integrated center communication system 1 with the upload folder (step S10).

Thus, in the business store communication system 2, when the database device 25 and the business store MCIF server 26, (collectively, the business store management MCIF system) download the customer information from the integrated center communication system 1, as shown in FIG. 6, a popup screen is displayed for communicatively reporting the customer's visit to the bank branch. The popup screen includes, for example, customer segment, the name of the customer, and the customer's visit status, such as visit time.

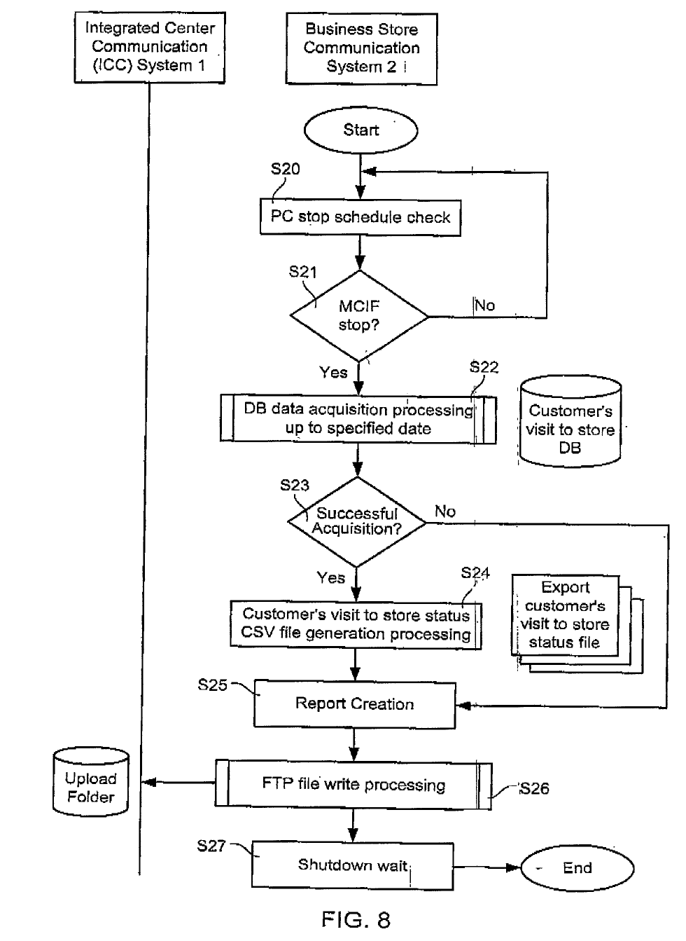

FIG. 8 is a flowchart of the detailed upload protocol of the customer information from the business store communication system 2 to the ICC system 1.

In FIG. 8, the small general purpose computer 24 of the business store communication system 2 checks the schedule of the business store MCIF server 26 (step S20). Then, when the business store MCIF server 26 stops (step S21: Yes) and is not currently processing data from ATMs, the current customer information is transferred from the database device 25 of the business store management MCIF system. The current customer information can be transferred at the end of normal business hours. This way, current and updated customer information is transferred at least daily to the ICC system 1.

When the transfer of the collected and updated information (customer information) of the status of bank utilization for each customer is successful (step S23: Yes), the business store MCIF server 26 generates the customer information according to each customer's visit to the store in a CSV (Comma Separated Value) file (step S24), and a success report of the FTP file acquisition is then created (step S25). If the transfer of information is not successful (step S23:No), processing moves to step 25 and an unsuccessful acquisition report FTP file is created. Subsequently, the FTP file is written (step 26) and this download result file is reported to the integrated center communication system 1 with the upload folder and processing enters the shutdown wait state (step S27).

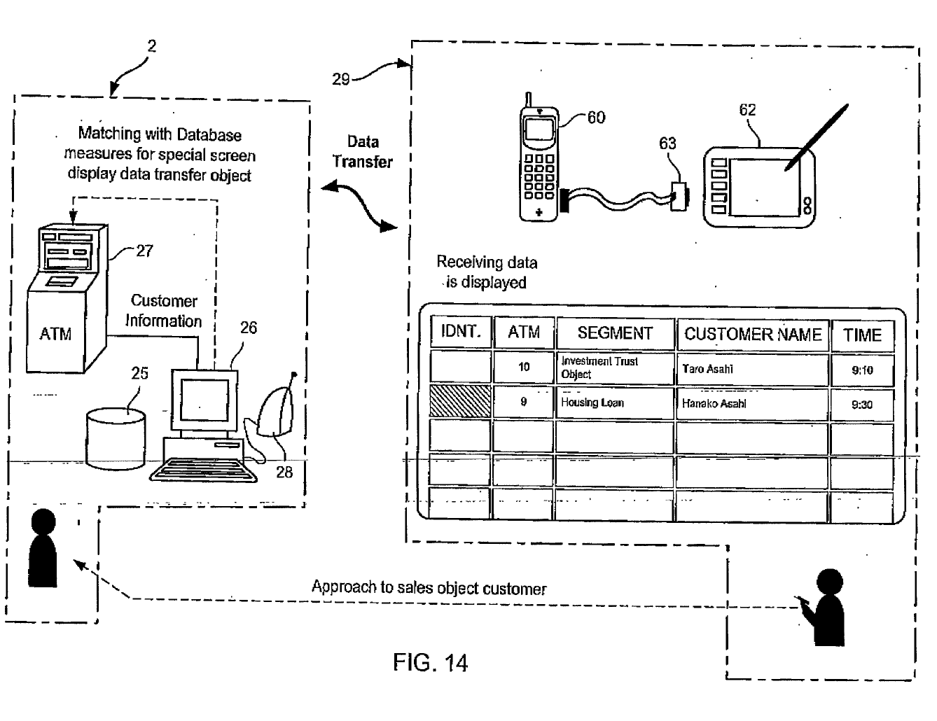

The MCIF system (at the integrated center communication system 1) demarcates (creates data base content components from customer information) and processes the customer information, and then establishes various guidance/promotional screens for customers based on the information. This campaign and service execution information for each customer is exported to the business store management MCIF systems (database device 25 and the business store MCIF server 26). The information is used to not only present screens to each customer, but also to provide reports to the branch office when the customer visits (to be described further in connection with FIGS. 14 through 17).

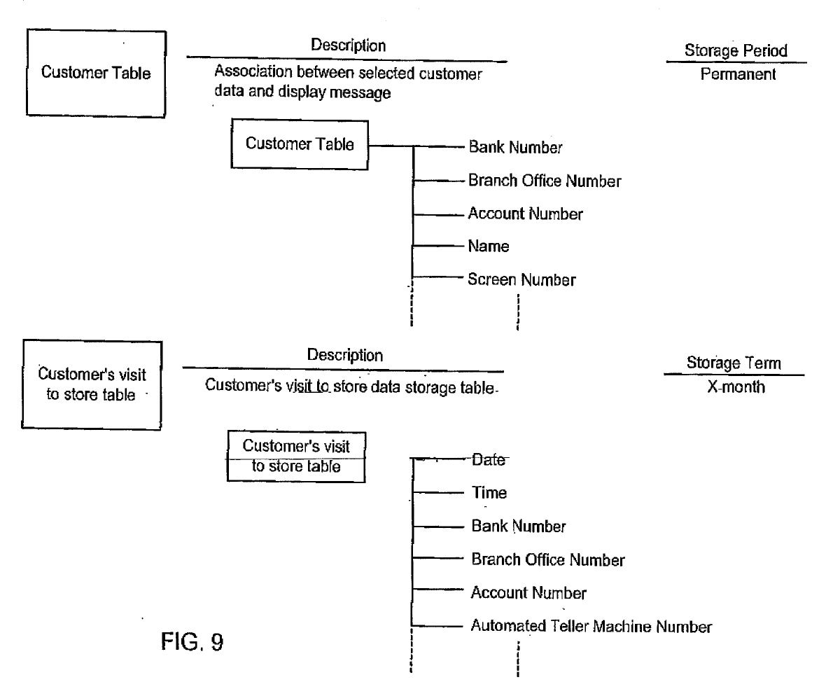

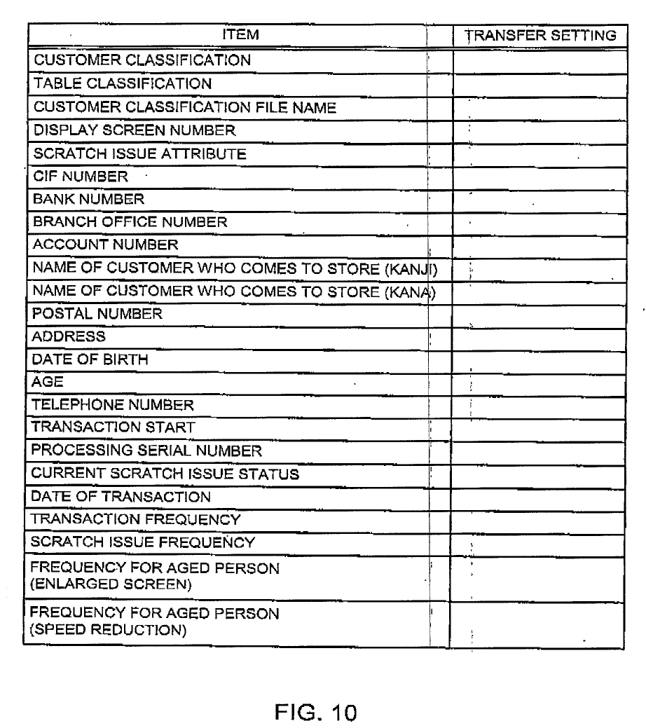

FIG. 9 is a drawing for describing the storage contents of the database device 25 in the business store communication system 2 of FIG. 1. FIG. 10 is a drawing for describing the detailed storage contents of the database device 25.

Referring to FIG. 9 and FIG. 10, the information described here is the customer information that the ICC MCIF system and the business store management MCIF system manage. The storage contents consist of a “Customer” table and a “Customer's visit to the store” table, and these stored contents are the customer attribute information. The contents include basic personal information about each customer and his/her accounts, and also information about the transactions conducted by the customer (updated at least daily). The customer table is stored permanently (as long as an account exists) and associates selected customer data (e.g., the bank number, business store (branch office) number, account number, name, screen number ID) with display messages. The “Customer's visit to the store” table includes data pertaining to each customer's visits to the ATMs at the branch or store, such as date of transaction, time, bank number, branch office (business store), ATM number, etc. It also specifies the storage term for this data, which as illustrated in FIG. 9 can be set by the bank for any “X” number of months (e.g., 1 month, 2 months, 3 months, etc.). Additionally, FIG. 10 shows a listing of the items of the customer information that may be stored in the tables at FIG. 9. The listing of items shown in FIG. 10 can be displayed to a bank branch employee at the server 26. The “transfer setting” column can be numbered by the employee in order to indicate those pieces of information that are to be transferred (via wireless TA 28) to the personal digital assistants 29.

When the customer comes to the store, selective setting is performed for the communicative reporting. This selection is performed corresponding to the campaign that is planned by the headquarters at the main store communication system 3 (main store). For example, during the campaign of a housing loan, a house purchasing age group and a repurchasing age group are selected. In this selection, the selective setting for executing the communicative reporting when the customer comes to the store is performed for the item (customer segment information) in the customer table and the customer's visit to the store table shown in FIG. 9. In such selection, the selective setting can be set according to the branch location, period of the visit, and the type of merchandise/housing of the specific customer in addition to, or in lieu of, any nationwide criteria that matches the attribute information of the customer visiting the ATM.

The item (customer segment information) in the customer table and the Customer's Visit to the Store table shown in FIG. 9 for which this selective setting is performed is demarcated and transferred when a request for downloading to the business store management MCIF systems (business store communication 2/database device 25 and the business store MCIF server 26) is received.

Additionally, the main store communication system 3 (the server 32 or the main store MCIF client 33) executes the registration of the customer segment information, the version management following the system modification, and the processing that acquires new information according to the customer's visit to the store from the integrated center communication system 1. The main store communication system 3 performs planning and scheduling of new campaigns and services based on the new information about each customer's visit to the store.

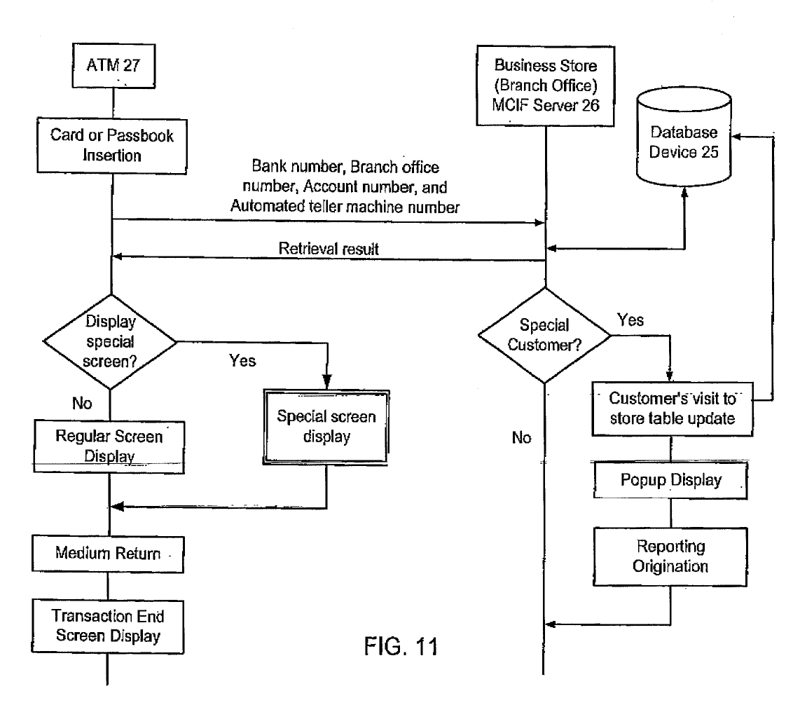

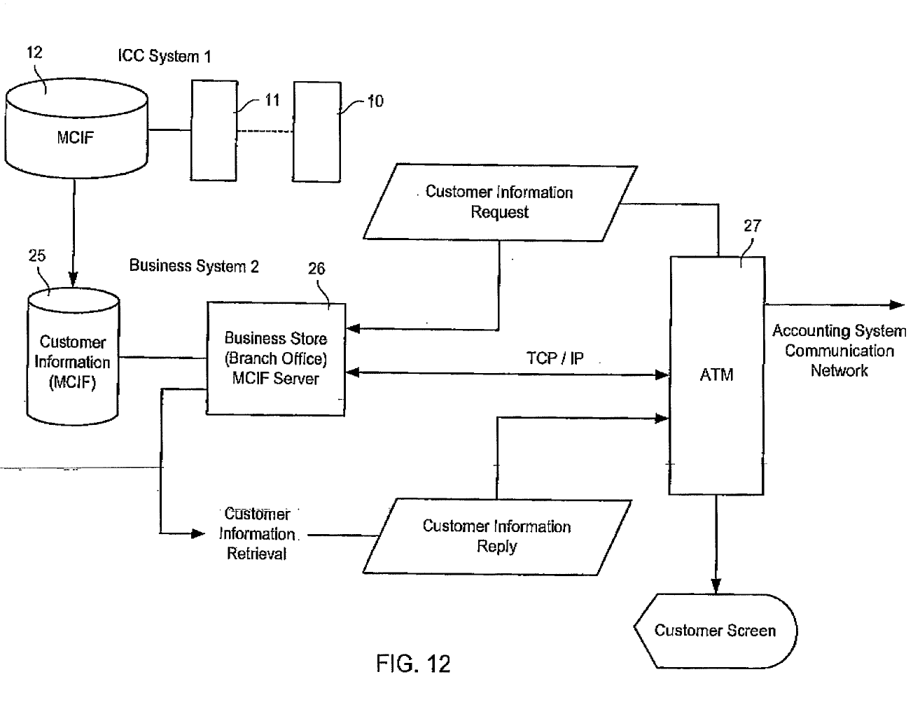

FIG. 11 is a flowchart sequence drawing showing the processing procedure between the ATM 27 and the business store management MCIF systems (database device 25 and the business store MCIF server 26). FIG. 12 is a block diagram showing an outline of the processing between the ATM 27 and the business store management MCIF systems (database device 25 and the business store MCIF server 26).

In FIG. 11 and FIG. 12, the customer information (collected information/segment information of the status of bank utilization—see FIGS. 9 and 10) demarcated from the MCIF system (integrated center communication system 1) is transferred and stored in the database device 25. The business store management MCIF systems (database device 25 and the business store MCIF server 26) then generate the reporting of customer information to the person in charge of business (and other employees) at the bank branch, from the server 26 and the wireless TA 28 to the personal digital assistant 29.

In FIGS. 11 and 12, when a bankcard or a passbook is inserted into the ATM 27, it transfers transaction-specific customer information to the business system 2. The transaction-specific information may include a customer ID, a bank ID number, a branch office ID number, an account number, a ATM ID number and the like, as well as data identifying the transaction, such as date, time, etc. (see the Customer table and the Customer's visit to the store table shown in FIG. 9). Then, the database engine of the business system 2 is activated. The business system 2 determines whether a specific or special screen display has been assigned to the customer. That information (“retrieval result”) is transmitted back to the ATM, and if there is a specific or special screen to be displayed for the customer account (“YES”), the ATM 27 displays the screen. If on the other hand, the business system 2 returns data indicating no specific screen was assigned to the customer's account (“NO”), then the ATM displays a standard or regular screen (a screen of avail able standard transaction items). After the display of a screen (or sequence of screens), and the transaction has been completed, the ATM returns to customer's card or passbook (medium), and a “transaction end” screen is displayed.

Further, the business store MCIF server 26 includes data in the “Customer's Visit to the Store” table when a customer is a special customer, and this is part of the retrieved customer service execution information. The customer's visit is updated in the database 25, and the small general purpose computer 23 of FIG. 1 performs a popup display for bringing this customer to the attention of the bank administrator. Then, the communicative reporting concerning a special customer's visit to the store is transmitted from the wireless TA 28 to the personal digital assistant 29 via the server 26, as shown in FIG. 1.

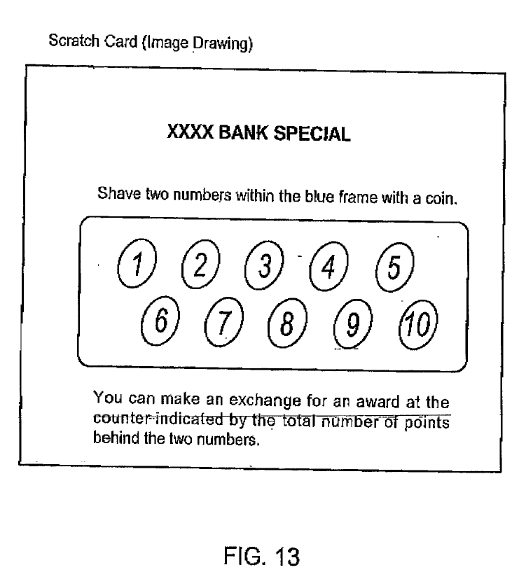

A specific example of a special service offer or promotion that might be used in conjunction with an ATM screen display, is described below in connection with FIG. 13.

In FIG. 13, the specific example of this service offer is a scratch card, dispensed by the printer 54 of the ATM 27. At the time the card is issued by the ATM 27, a special screen may appear with directions for using the card. In the present example, depending on the total points revealed when a customer uses the scratch card, premiums or awards are offered to the customer.

In this example, the reaction of the customer to the campaign offer and service offer at the ATM 27 is collected in the database device 25 and the business store MCIF server 26 as updated customer information and is later transferred as updated information to the integrated center communication system 1. Further, any redemption of the scratch card by a customer is made in a conversation with a bank employee, and this information can be transferred from the small general purpose computer 23 to the database device 25 and the business store MCIF server 26.

As a result, more accurate customer information can be collected. Accordingly, based on this new customer information, every time the customer comes to the store, a more effective business promotion activity is enabled.

The customer information collected through such business promotion activity is collected by the integrated center communication system 1, and the business store communication system 2 that downloads this customer information (from the ICC system 1) communicatively reports the customer's visit to the store and the customer information to the business department of the bank. That is, the effective business promotion activity that matches each customer will be performed by the deposit manager, the finance manager, and the branch manager together with the business escort (customer service representative) and the person in charge of business in a bank.

The communicative reporting of the customer's visit to the store and the customer information into the business division will now be described.

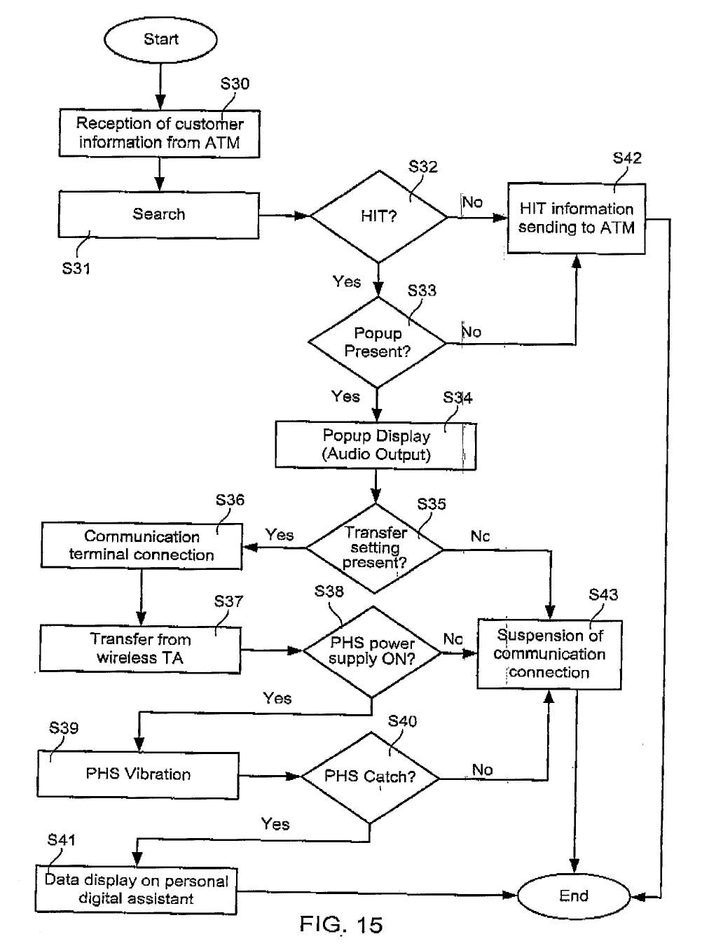

FIG. 14 is a drawing illustrating the reporting of the customer's visit to the store along with associated customer information, and the subsequent business promotion activity. FIG. 15 is a flowchart of the processing procedure used in connection with the reporting.

In FIG. 14, the reporting is performed from the wireless TA 28 to the personal digital assistant 29 via the server 26 shown in FIG. 1 in the business store communication reporting system. The transferred data is displayed on the screen of the personal digital assistant 29. The reporting is done pursuant to the items (customer segment information) in the “Customer” table and the “Customer's Visit to the Store” table shown in FIG. 9.

In the communicative reporting concerning the customer's visit to the store, the business store management MCIF systems (database device 25 and the business store MCIF server 26) of the business store communication system 2 automatically receive the customer information from the ATM 27 (step S30). The business store MCIF server 26 of the business store management MCIF systems retrieves customer information pertaining to this customer from the database 25 (step S31).

When there is a “hit” for the customer (step S32: Yes), indicating a special customer (one for whom bank employees may need to be alerted), the existence of a popup display for the customer is determined (step S33). When it is set (Yes), the business store MCIF server 26 performs the popup display, e.g., at computers 23 or 24, or an audio alert within the branch (step S34). Next, the system determines whether there is to be the transfer (wireless transmission) of the customer information to bank employees (step S35). When the transfer is set (Yes), the transmission from the wireless TA 28 to the personal digital assistant 29 is executed (steps S36, S37). When this transmission (communicative reporting) is executed, the screen indicating that a person in charge of business will make a visit can also be displayed at the ATM color display device 46 shown in FIG. 2.

In the example of the personal digital assistant 29A of FIG. 3, and assuming a PHS system is used, the power on (ON) of the cellular phone 60 of the PHS is determined (step S38). When it is on (yes), the incoming information from the wireless TA 28 is reported by a vibrator, for example. Then the system determines whether the cellular phone 60 of the PHS receives a transfer of data from the wireless TA 28 (step S40). When this receiving is performed (Yes), the customer information is transferred to the palmtop computer 62. The palmtop computer 62 displays (step S41) the received transfer data (customer information) on the screen. If the data is not received (or if there is no transfer setting, or if the phone 60 is not on), the communication is suspended (step S43).

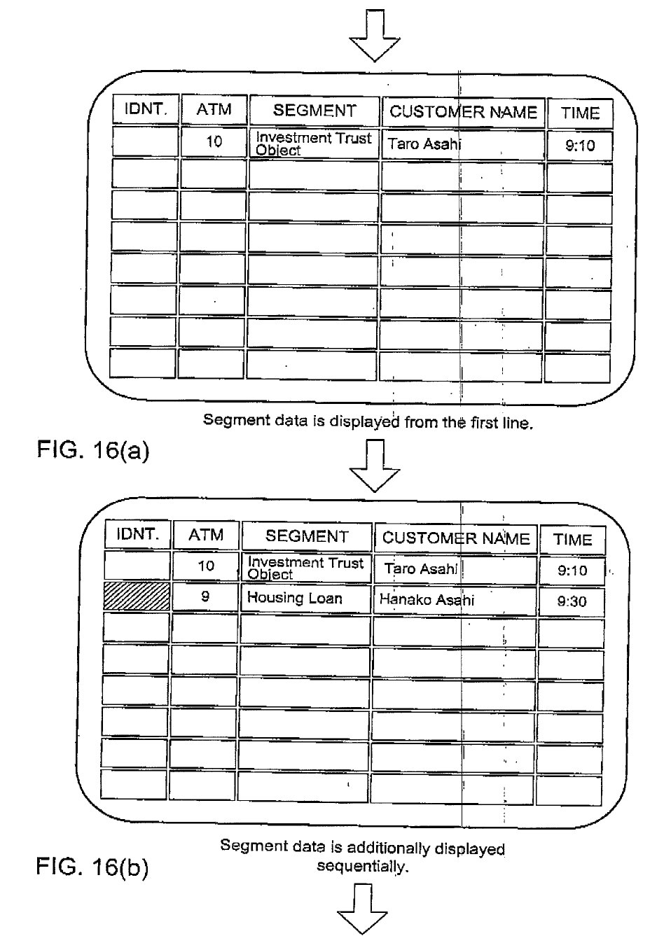

FIGS. 16(a) and 16(b) illustrate the appearance of screen displays at the palmtop computer 62. In the first screen of FIG. 16(a), the display is for a single customer visiting an ATM at the branch or store. In FIG. 16(b), a second customer subsequently arrives at an ATM, and information for both that second customer and the previous customer is displayed.

In the display contents of this communicative reporting, for example, in FIG. 16(a), the customer is visiting at ATM number “10,” and “Investment Trust Object” is identified as the customer segment (the type of promotion activity that may be pertinent to the customer). Further, the customer name “Taro Asahi” that corresponds to this customer segment is displayed, and the “Operation Start Time” of the ATM 27 is displayed.

The person in charge of business who receives the information from this display screen, for example, the business escort (customer service representative) shown in FIG. 14, interviews the customer who is operating the ATM number 10 and performs the business promotion activity. For example, a supplementary explanation, such as the advantages to obtaining the “Investment Trust Object” services (the bank's investment services), may be given.

When this customer name “Taro Asahi” is designated as an object, the detailed customer information (refer to FIG. 10) about this customer maybe downloaded from the business store management MCIF systems (database device 25 and the business store MCIF server 26) of the business store communication system 2 to the computer 23. Accordingly, more accurate business for the customer is enabled.

Next, in the display screen of FIG. 16(b) following FIG. 16(a), information on the customer who next comes to the store or bank is displayed on the screen. Here, the ATM Number “9”, “Housing Loan”, customer name “Hanako Asahi”, and “Operation Starting Time” of the customer who is operating the ATM 27, are displayed. Also, in this event, the person in charge of business who receives the information from the display screen, for example, the business escort shown in FIG. 14, interviews the customer who is operating the ATM number 9 and performs business promotion activity. For example, a supplementary explanation, such the advantages to the customer of obtaining a “Housing Loan,” may be given.

As illustrated in FIG. 16(b), a mark (special color) can be displayed in the type column “IDNT”. This is used for calling special attention to a customer. The selection of this warning mark is previously set in the detailed storage contents of the database device 25 shown in FIG. 9 and FIG. 10. That is, important (excellent) customers are marked and thus distinguished from customers who cause problems (repayment is delayed/bad), for example.

Moreover, when this customer name “Hanako Asahi” is designated as an object, the detailed customer information (refer to FIG. 10) about this customer is downloaded from the business store management MCIF systems (database device 25 and the business store MCIF server 26) of the business store communication system 2 and is displayed on a screen, for example, at computer 23. Accordingly, more accurate business information for each customer may be obtained.

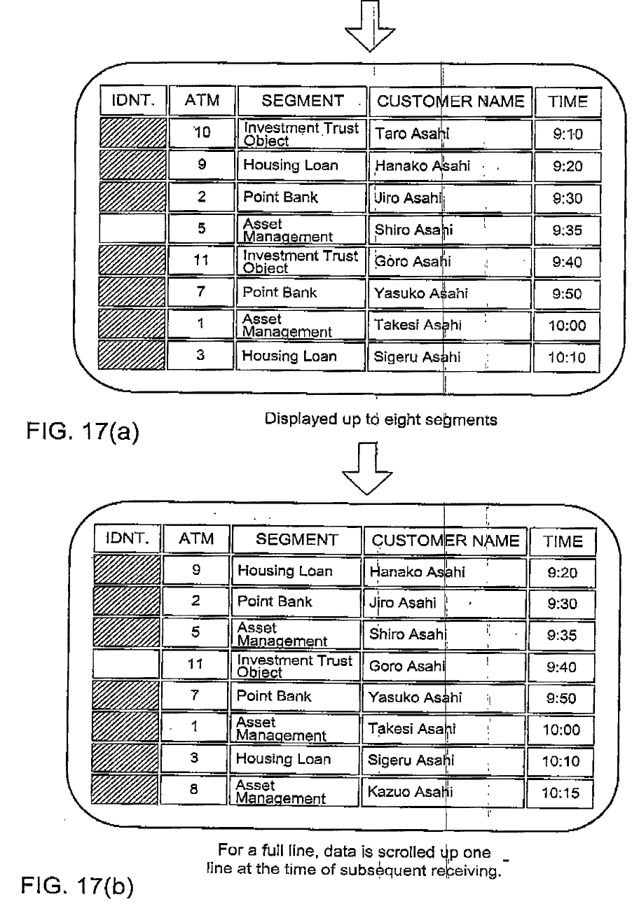

FIGS. 17(a) and 17(b) illustrate additional screens that may be displayed on the palmtop computer 62. In FIG. 17(a), the maximum number of displayable customers is shown (eight customers). For each customer, there is shown the ATM number, segment (promotional service to be offered), customer name and time that the visit began. When an additional customer visits (FIG. 17(b)), the information pertaining to the earliest visit is deleted from the screen, and the newest customer is displayed at the bottom of the screen (the screen is automatically scrolled up to reveal and report on the newest customer).

Next, the communicative reporting that corresponds to the configuration of the personal digital assistants 29 shown in FIG. 3 and FIG. 4 is described.

An earlier description was for the personal digital assistant 29A (cellular phone 60 of the in-house PHS/palmtop computer 62) shown in FIG. 3. The personal digital assistant 29B uses the small general purpose computer 61 that is a fixed device instead of the palmtop computer 62. The display contents are the same contents as FIG. 16(a), (b) and FIG. 17(a), (b) described above. In this configuration, the in-house PHS system is used and the customer information concerning the customer's visit to the store can be displayed on the large screen of the small general purpose computer 61. The deposit manager, the finance manager, and the branch manager can browse the display screen individually or with the person in charge of business, and can perform the effective business promotion activity to the customer together with floor staff (i.e., a customer service representative).

In the personal digital assistant 29C of FIG. 3, the customer information is communicatively reported from the cellular phone 60 (via a bluetooth handset system 64) to a palmtop computer 65. Since wireless connection is used, the cellular phone 60 is housed in a business suit pocket and can be operated by holding only the palmtop computer 65 in one hand. Thus, equipment portability (and business activity) is facilitated. These contents are the same contents as FIG. 16(a), (b) and FIG. 17(a), (b). That is, the deposit manager, the finance manager, and the branch manager can browse the display screen individually or together with the person in charge of business, and can perform the effective business promotion activity to the customer together with a customer service representative.

Next, in the configuration shown in FIG. 4, the PHS public mobile communication network can be used instead of the wireless TA 28. The personal digital assistants 75A to 75C are identical with the personal digital assistants 29A to 29C described above. The display contents are also the same contents as FIG. 16(a), (b) and FIG. 17(a), (b) described above. The business activities of the person in charge of business, the deposit manager, the finance manager, and the branch manager are also identical.

In this configuration, the need for the wireless TA 28 is eliminated and the maintenance is simplified. Further, in a system that uses this PHS public mobile communication network, misuse or tampering with customer information can be minimized. For example, the misuse of this customer information includes wiretapping (malicious data acquisition over a communication path), disapproval (negation of communication in a communication remote party), modification (modification of transmission data over the communication path by the third party), and posing (the third party poses as another person to perform data transmission). Therefore, it is desirable that countermeasures for preventing the destruction of the customer information be taken using a conventional encryption system and public key encryption, such as RSA or MH (Modified Huffman) data compression/encryption.

In one further embodiment, in the system that uses the PHS public mobile communication network, the transfer of new customer information directly to the MCIF system (integrated center communication system 1) is done directly from the personal digital assistants 29A to 29C, rather than through the business store management MCIF systems (database device 25 and the business store MCIF server 26). In such an embodiment, the MCIF system (integrated center communication system 1 of FIG. 1) would be provided with a communication connection terminal of the PHS public mobile communication system (not shown) or alternatively, the frame relay network 4 would be connected through a gateway device to a PHS public mobile communication network.

Still further embodiments of communicative reporting in accordance with the present invention will be described below.

The communicative reporting is executed by two-way communication using the TCP/IP link shown in FIG. 5 for the personal digital assistant 29 via the wireless TA 28. Accordingly, new customer information obtained from business activity can be transferred from the palmtop computers 62, 65 and the small general purpose computer 61 in the various embodiments of the personal digital assistant 29 shown in FIG. 3 and FIG. 4 to the business store management MCIF systems (database device 25 and the business store MCIF server 26).

Further, an incoming vibrator alert in the personal digital terminal 29 can be included in the communicative reporting. In addition to this, an audio output that reports the customer's visit to the store can be performed by mounting a sound source board (audio output means) in the personal digital assistant 29.

The customer's visit to the store while business work is being performed can easily be brought to attention of bank employees. The new customer's visit to the store is made clear by making the customer name column of the customer's visit to the store blink (flash) on the display screen. Further, the display reporting can be performed by providing a light emitting display in the personal digital assistant 29 at an easy-to-see position for the person in charge of business.

As clear from the above description, the customer information is collected and updated (at the integrated center communication system) via a communication line network. The business store or branch (business store communication system) downloads and stores this collected customer information, and based on this status of bank utilization (customer use of bank), the customer's visit to the store is reported to the person in charge of business via the business store communication reporting system together with the information of the status of bank utilization of the customer.

As a result, bank employees who receive the communicative reporting can perform effective business promotion activity in which they immediately interview the customer.

Further, according to the present invention, more accurate information about the status of bank utilization by the customer can be collected and reported by bank employees. As a result, based on the new information about the status of bank utilization by the customer, there can be further effective business promotion activity with the customer during the next visit to the bank or store.

While a detailed description of exemplary embodiments has been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for reporting on a customer at the branch of a commercial establishment, the establishment having a central system and a branch system, the central system maintaining customer service information pertaining to services offered by the establishment and associated with the customer, and the branch system having a self-service terminal for the customer to conduct transactions at the branch, the method comprising:
transferring customer service information from the central system to the branch system;
generating customer-specific information at the self-service terminal when a customer initiates a transaction at the self-service terminal, said customer-specific information identifying the customer; and
transmitting a report on the customer from the branch system in response to the generation of customer-specific information at the self-service terminal, the report identifying the customer and the customer-service information.

2. The method of claim 1, wherein the report is provided to a employee of the establishment at the branch, for use in providing personal attention to the customer in connection with the customer service information.

3. The method of claim 2, wherein the customer service information relates to services offered by the establishment that may be of interest to the customer at the self-service terminal.

4. The method of claim 3, wherein the branch system further comprises a database for storing the customer service information from the central system, and a server for managing the database and for receiving customer-specific information from the self-service terminal when the customer initiates a transaction at the self-service terminal, the server causing the report to be transmitted in response to the customer specific information.

5. The method of claim 4, wherein the customer service information is updated at the branch system and provided to the central system after the employee provides personal attention to the customer, the updated customer service information reflecting the reaction of the customer to the customer service information and the status of any current transaction by the customer at the self-service terminal.

6. The method of claim 1, wherein the commercial establishment is a bank and the customer service information pertains to financial services offered by the bank, wherein the self-service terminal is an automated teller machine (ATM), and wherein the ATM displays the customer service information to the customer when conducting a transaction at the ATM.

7. The method of claim 6, wherein the step of transferring customer service information from the central system to the branch system is performed periodically at one or more predetermined times during each day.

8. The method of claim 7, further comprising displaying a screen at the ATM for informing the customer that a bank representative will be approaching the customer to provide further customer service information.

9. The method of claim 8, wherein the report is transmitted from the branch system to terminals accessible to bank representatives.

10. The method of claim 9, wherein at least one of the terminals is a portable terminal, and wherein the report is transmitted to the portable terminal via wireless transmission.

11. The method of claim 10, wherein at least one of the terminals is a stationary terminal located within the branch.

12. A bank network, comprising:
a central system that collects and stores customer attribute information and customer service information, the customer attribute information pertaining to personal information of a customer, and the customer service information pertaining to services offered by the bank and associated with the customer;
a branch system, including one or more automated teller machines (ATMs) located at a branch office of the bank, the branch system receiving the personal attribute information and the customer service information from the central system, and transferring the customer service information to the ATM for display when the customer conducts a transaction at the ATM; and
a terminal for receiving a report from the branch system when the customer conducts a transaction at the ATM, the report identifying the customer and the customer service information.

13. The bank network of claim 12, wherein the customer service information relates to services offered by the bank that may be of interest to the customer at the ATM.

14. The bank network of claim 13, wherein the report received at the terminal is provided to a bank representative at the branch office, for use in providing personal attention to the customer in connection with the customer service information

15. The bank network of claim 14, wherein the branch system further comprises a database for storing the customer service information and customer attribute information from the central system, and a server for managing the database and for receiving customer specific information from the ATM when the customer initiates a transaction at the ATM, the server causing the report to be transmitted in response to the customer specific information matching customer attribute information stored in the database.

16. The bank network of claim 15, wherein the customer service information is updated at the branch system and provided to the central system after the bank representative provides personal attention to the customer, the updated customer service information reflecting the reaction of the customer to the customer service information and the status of any current transaction by the customer at the self-service terminal.

17. The bank network of claim 16, wherein the central system periodically transfers the personal attribute information and the customer service information to the branch system, at one or more predetermined times during each day.

18. The bank network of claim 17, wherein in response to the report being received at the terminal, the ATM displays a message informing the customer that a bank representative will be approaching the customer to provide further customer service information.

19. The bank network of claim 18, wherein the terminal is a portable terminal, and wherein the report is transmitted to the portable terminal via wireless transmission from the branch system.

20. The bank network of claim 19, further comprising a second terminal for receiving the report from the branch system when the customer conducts a transaction at the ATM, wherein the second terminals is a stationary terminal located within the branch.

21. The bank network of claim 20, wherein the portable terminal is in two way communication with the branch system, and wherein the portable terminal comprises a wireless telephone connected to a palmtop computer, the palmtop computer displaying the report.

22. The bank network of claim 21, wherein the connection between the wireless telephone and the palmtop computer is a wireline connection.

23. The bank network of claim 21, wherein the connection between the wireless telephone and the palmtop computer is a wireless bluetooth connection.
